(19) United States
(12) Patent Application Publication
(10) Pub. No.: US 2025/0020194 A1
(43) Pub. Date: Jan. 16, 2025

(54) PUSH ROD DEVICE

(71) Applicant: Chen-Yang WU, Taipei (TW)

(72) Inventor: Chen-Yang WU, Taipei (TW)

(21) Appl. No.: 18/568,881

(22) PCT Filed: Jun. 10, 2022
(86) PCT No.: PCT/CN2022/097996

§ 371 Date: Dec. 11, 2023

(30) Foreign Application Priority Data
Jun. 10, 2021 (CN) 202110650203.5

(51) Int. Cl. F16H 25/20; B62D 5/04; F16H 25/24; F16H 37/04; H01F 7/08; H01F 7/16; H02K 7/06; H02K 7/116

(52) U.S. Cl. CPC F16H 25/20; B62D 5/0403; B62D 5/0445; F16H 37/04; H01F 7/081; H01F 7/16; H02K 7/06; H02K 7/116; B62D 5/0418; F16H 2025/2075; F16H 25/2418

(57) ABSTRACT

A push rod device includes a rotating shaft, drive motor and telescopic assembly. The drive motor is connected to the rotating shaft, adapted to drive it to rotate. The telescopic assembly can be movably provided on the rotating shaft. When the rotating shaft is rotated, the telescopic assembly can be telescoped along the extension direction of the rotating shaft. In use, the present invention is very convenient, and the structure thereof is simple, capable of effectively saving installation space and reducing installation difficulty.

### TECHNICAL FIELD

The present invention relates to a push rod device, and more particularly to an easy-operate push rod device.

### BACKGROUND

Existing push rod devices usually use air cylinders, hydraulic cylinders or mechanical push rods as power sources to push objects to which thrust is intended to move back and forth. However, the storage volume required for the liquid or gas in the cylinder or hydraulic cylinder is relatively large, and the use also requires the installation of pipelines for transporting gas/liquid, which takes up more space and is more difficult to install, so there is still room for improvement.

### SUMMARY

An object of the present invention is to provide an operationally easy and structurally simple push rod device.

The present invention proposes a push rod device, including: a rotating shaft; a drive motor, connected to the rotating shaft, and adapted to drive the rotating shaft to rotate; and a telescopic assembly, capable of movably provided on the rotating shaft, and the telescopic assembly being telescoped along an extension direction of the rotating shaft when the rotating shat is rotated.

The telescopic assembly of the push rod device of the present invention includes a bearing seat allowing the rotating shaft to be rotatably passed therethrough, an outer sleeve fixed to the bearing seat, a collar element movably sleeved on the rotating shaft, and an inner sleeve positioned inside the outer sleeve and fixed to the collar element.

The telescopic assembly of the push rod device of the present invention further has a first sealing element fixed to the collar element and sleeved between the rotating shaft and outer sleeve, and a second sealing element sleeved between one end of the rotating shaft away from the bearing seat and the inner sleeve.

An outer wall surface of the inner sleeve of the push rod device of the present invention is recessed to form a plurality of positioning grooves allowing a plurality of corresponding positioning blocks to be engaged therewith, enabling the inner sleeve to be positioned relate to the rotating shaft.

The telescopic assembly of the push rod device of the present invention includes a bearing seat allowing the rotating shaft to be rotatably passed therethrough, a collar element movably engaged with the rotating shaft, and an inner sleeve fixed to the collar element.

The telescopic assembly of the push rod device of the present invention further has a second sealing element sleeved between one end of the rotating shaft away from the bearing seat and the inner sleeve.

The telescopic assembly of the push rod device of the present invention further has a plurality of lock blocks protruded outward from an outer wall surface of the inner sleeve, and the lock blocks allow a plurality of corresponding positioning blocks to be engaged therewith, enabling the inner sleeve to be positioned relative to the rotating shaft.

An outer wall surface of the inner sleeve of the push rod device of the present invention is recessed to form a plurality of positioning grooves allowing a plurality of corresponding positioning blocks to be engaged therewith, enabling the inner sleeve to be positioned relative to the rotating shaft.

The lock blocks of the push rod device of the present invention are respectively provided on two sides of the inner sleeve, and the lock blocks on each side are arranged coherently with each other.

The push rod device of the present invention further includes a steering gear fixedly sleeved on the inner sleeve, and the lock blocks are respectively provided on two sides of the inner sleeve, and the lock blocks on each side are positioned on upper and lower sides of the steering gear.

The push rod device of the present invention further includes a steering gear fixedly sleeved on the inner sleeve.

The push rod device of the present invention further includes a cylinder body seat allowing the inner sleeve to be movably passed therethrough.

The push rod device of the present invention further includes a deceleration mechanism connected to the drive motor and rotating shaft.

The deceleration mechanism of the push rod device of the present invention the is a planetary gear train.

The present invention proposes a push rod device, including: a telescopic assembly, including an inner rod, and an outer cylinder movably sleeved on the inner rod; a first magnetic unit, provided on an end of the inner rod; and a second magnetic unit, provided inside the outer cylinder and corresponding to a position of the first magnetic unit, wherein, the first magnetic unit and second magnetic unit are attracted to or repelled from each other through magnetic force, thereby driving the outer cylinder to telescope along the inner rod.

The first magnetic unit and second magnetic unit of the push rod device of the present invention respectively are an electromagnet assembly.

Each of the electromagnet assemblies of the push rod device of the present invention has an extension column, an insulator unit provided on the extension column, a core element provided inside the insulator unit, and a coil provided inside the insulator unit and surrounding the core element, wherein one of the extension columns is fixed to the inner rod, and another extension column is fixed to the outer cylinder.

Each of the extension columns of the push rod device of the present invention has a main body part, and a cover part connected to an end of the main body part and having a diameter larger than the main body part, the insulator unit includes an insulating outer cylinder sleeved on the extension column, a colloid covered on the core element and coil together with the insulating outer cylinder, and two lock covers, wherein one of the lock covers is provided between the colloid and insulating outer cylinder, and another lock cover is provided between the colloid and cover part.

The first magnetic unit of the push rod device of the present invention is an electromagnet assembly, and the second magnetic unit is a permanent magnet.

Each of the electromagnet assemblies of the push rod device of the present invention has an extension column fixed to the inner rod, an insulator unit provided on the extension column, a core element provided inside the insulator unit, and a coil provided inside the insulator unit and surrounding the core element.

The extension column of the push rod device of the present invention has a main body part, and a cover part connected to an end of the main body part and having a diameter larger than the main body part, the insulator unit includes an insulating outer cylinder sleeved on the extension column, a colloid covered on the core element and coil together with the insulating outer cylinder, and two lock covers, one of the lock covers is provided between the colloid and insulating outer cylinder, and another lock cover is provided between the colloid and cover part.

The push rod device of the present invention further includes a steering gear fixedly sleeved on the outer cylinder.

The push rod device of the present invention further includes a steering gear fixedly sleeved on the inner rod.

The push rod device of the present invention further includes a cylinder body seat allowing the outer cylinder to be movably passed therethrough.

The outer cylinder of the push rod device of the present invention is recessed to form a plurality of positioning grooves allowing a plurality of corresponding positioning blocks to be engaged therewith, enabling the outer cylinder to be positioned relative to the inner rod.

The push rod device of the present invention further includes a plurality of lock blocks protruded outward from an outer wall surface of the outer cylinder, and the lock blocks allow a plurality of corresponding positioning blocks to be engaged therewith, enabling the outer cylinder to be positioned relative to the inner rod.

The lock blocks of the push rod device of the present invention are respectively provided on two sides of the outer cylinder, and the lock blocks on each side are arranged coherently with each other.

The push rod device of the present invention further including a steering gear fixedly sleeved on the outer cylinder, and the lock blocks are respectively provided inside the outer cylinder, and the lock blocks on each side are positioned on upper and lower sides of the steering gear.

The inner rod of the push rod device of the present invention is recessed to form a plurality of positioning grooves allowing a plurality of corresponding positioning blocks to be engaged therewith, enabling the inner rod to be positioned relative to the outer cylinder.

The core element of the push rod device of the present invention is a soft iron core, nanoscale rare earth structure or silicon steel sheet laminated structure.

The beneficial effect of the present invention is that by using the driving motor to drive the rotating shaft to rotate, the telescopic assembly can be moved along the extension direction of the rotating shaft to achieve the function of pushing the object. The present invention is very convenient to use, and the simple structure can effectively save space required for installation and reduce installation difficulty.

### BRIEF DESCRIPTION OF THE DRAWINGS

FIG. 1 is a partially cross-sectional view of a first embodiment of a push rod device of the present invention;

FIG. 2 is a partially cross-sectional view of the first embodiment, illustrating an extension state of the first embodiment;

FIG. 2A is partially cross-sectional view of a variant embodiment of the first embodiment of the push rod device of the present invention;

FIG. 3 is a partially cross-sectional view, illustrating the application of the first embodiment to a steering system;

FIG. 4 is a schematic view, illustrating the application of the first embodiment to a deceleration switching mechanism;

FIG. 4A is a schematic view, illustrating the application of the first embodiment to another deceleration switching mechanism;

FIG. 5 is a block diagram, illustrating the application of the first embodiment to a range extension system;

FIG. 6 is a partially cross-sectional view, illustrating another variant form of the first variant form;

FIG. 7 is a partially cross-sectional view of a second embodiment of a push rod device of the present invention;

FIGS. 8 and 9 respectively are a schematic view, illustrating the application of the first embodiment to a brake device;

FIG. 10 is a partially cross-sectional view of a third embodiment of a push rod device of the present invention;

FIG. 10A is a partially cross-sectional view of a variant embodiment of the third embodiment of a push rod device of the present invention;

FIG. 11 is a partially cross-sectional view of a fourth embodiment of a push rod device of the present invention;

FIG. 11A is a partially cross-sectional view of a variant embodiment of the third embodiment of a push rod device of the present invention;

FIG. 12 is a side view of the application of the third embodiment of a push rod device of the present invention to a steering system;

FIG. 13 is a partially cross-sectional view of a fifth embodiment of a push rod device of the present invention;

FIG. 14 is a partially cross-sectional view of a sixth embodiment of a push rod device of the present invention, illustrating an electromagnet assembly;

FIG. 14A is a partially cross-sectional view of a first variant embodiment of the sixth embodiment, illustrating the electromagnet assembly;

FIG. 14B is a partially cross-sectional view of a second variant embodiment of the sixth embodiment, illustrating the electromagnet assembly;

FIG. 14C is a side view of a third variant embodiment of the sixth embodiment of a push rod device of the present invention;

FIG. 14D is a side view of the third variant embodiment of the sixth embodiment of a push rod device of the present invention;

FIG. 15 is a side view, illustrating a seventh embodiment of a push rod device of the present invention applied to a steering system;

FIG. 16 is a partially cross-sectional view of an eighth embodiment of a push rod device of the present invention;

FIG. 17 is a partially cross-sectional view of a ninth embodiment of a push rod device of the present invention;

FIG. 18 is a partially cross-sectional view of a tenth embodiment of a push rod device of the present invention;

FIG. 18A is a partially cross-sectional view of a first variant embodiment of the tenth embodiment of a push rod device of the present invention;

FIG. 18B is a partially cross-sectional view of a second variant embodiment of the tenth embodiment of a push rod device of the present invention;

FIG. 18C is a partially cross-sectional view of a third variant embodiment of the tenth embodiment of a push rod device of the present invention;

FIG. 18D is a partially cross-sectional view of a fourth variant embodiment of the tenth embodiment of a push rod device of the present invention;

FIG. 19 is a partially cross-sectional view of an eleventh embodiment of a push rod of the present invention;

FIG. 20 is a partially cross-sectional view of a twelfth embodiment of a push rod of the present invention;

FIG. 21 is a partially cross-sectional view of a thirteen embodiment of a push rod of the present invention;

FIG. 22 is a partially cross-sectional view of a fourteen embodiment of a push rod of the present invention;

FIG. 23A is a partially cross-sectional view of a fifteen embodiment of a push rod device of the present invention;

FIG. 23B is a partially cross-sectional view of a first variant embodiment of the fifth embodiment of a push rod device of the present invention;

FIG. 24 is a partially cross-sectional view of a second variant embodiment of the fifth embodiment of a push rod device of the present invention;

FIG. 25 is a partial cross-sectional view of a sixteen embodiment of a push rod device of the present invention;

FIG. 26A is a side view of an extension frame of a steering unit of a steering system;

FIG. 26B is a top view of the extension frame;

FIG. 27A is a side view of a variant form of the extension frame of the steering unit of the steering system;

FIG. 27B is a top view of the variant form of the extension frame; and

FIG. 28 is a side view, illustrating the third variant embodiment of the sixth embodiment of a push rod device of the present invention applied to a steering system.

### DETAILED DESCRIPTION

The present invention will be described in detail below in conjunction with the accompanying drawings and embodiments.

Before the present invention is described in detail, it should be noted that in the following description, similar components are designated with the same numbering.

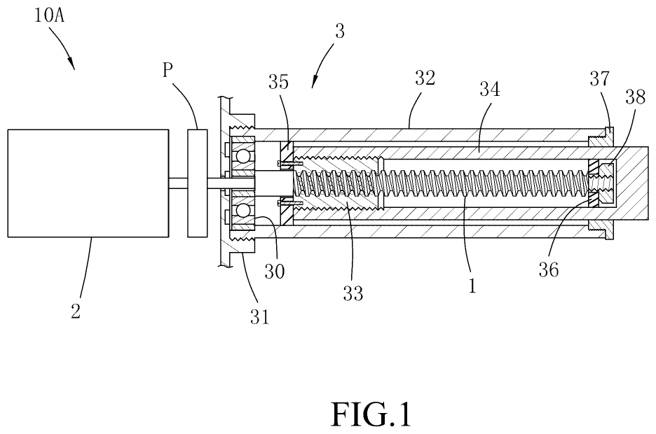

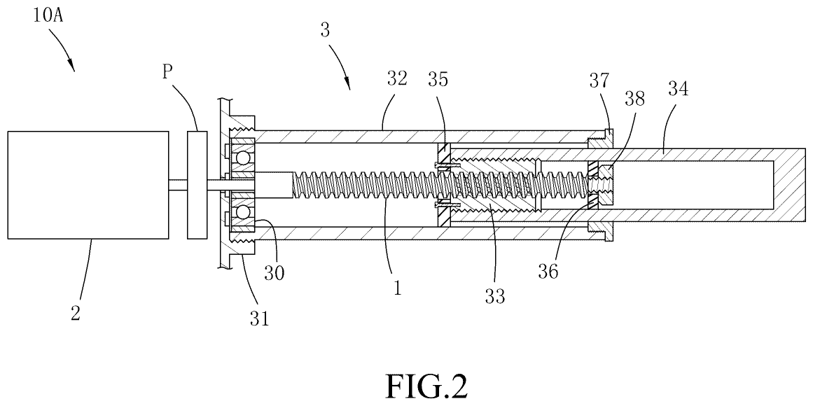

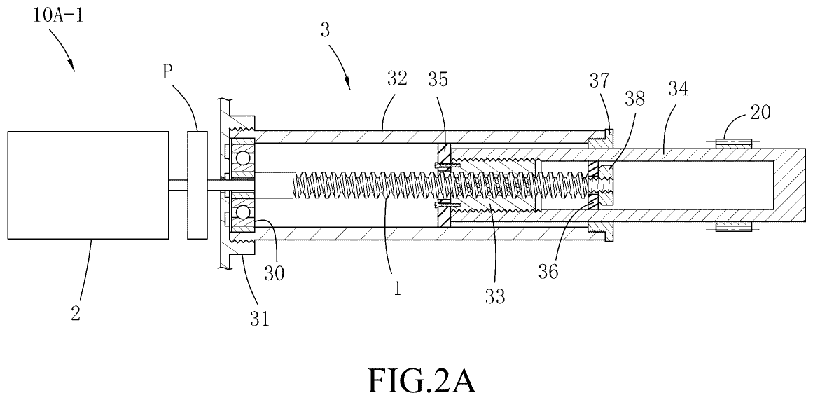

Referring to FIGS. 1 and 2, in a first embodiment, a push rod device 10 of the present invention includes a rotating shaft 1, drive module 2, telescopic assembly 3, and reduction mechanism P.

The drive motor 2 is in connection with the rotating shaft 1, adapted to drive the rotating shaft 1 to rotate. The telescopic assembly 3 may be movably provided on the rotating shaft 1. When the rotating shaft 1 is rotated, the telescopic assembly 3 can be telescoped back and forth along the extension direction of the rotating shaft 1. The telescopic assembly 3 includes a bearing seat 31 allowing the rotating shaft 1 to be movably passed through it, a bearing 30 provided on the bearing seat 31, an outer sleeve fixed to the bearing seat 31, a collar element 33 movably sleeved on the rotating shaft 1, an inner sleeve 34 positioned inside the outer sleeve 32 and fixed to the collar element 33, a first sealing element 35 fixed to the collar element 33 and sleeved between the rotating shaft 1 and the outer sleeve 32, and a second sealing element 36 sleeved between one end of the rotating shaft 1 away from the bearing seat 31 and the inner sleeve 34. In the embodiment, the reduction mechanism P may be a planetary gear train, but is not limited thereto. The collar element 33 is threaded on the rotating shaft 1, and when the rotating shaft 1 is being rotated, the collar element 33 and inner sleeve 34 of the telescopic assembly 3 can be moved back and forth along the extension direction of the rotating shaft 1.

Referring to FIG. 2A, which shows a first variant embodiment of the first embodiment. In the first variant embodiment, a push rod device 10A-1 of the present invention is similar to the push rod device 10A of the first embodiment, the difference between them is that the push rod device 10A-1 further includes a steering gear 20 fixedly sleeved on the inner sleeve 34.

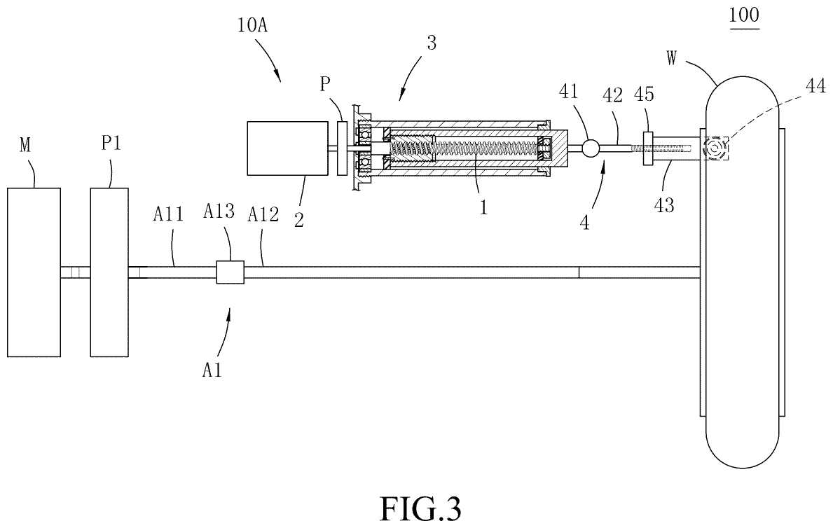

Referring to FIG. 3, the push rod device 10A of the present invention can be applied to a vehicle steering system 100, which includes a wheel motor M, a first transmission mechanism P1, an axle unit A1 and a push rod mechanism 4. The axle unit A1 is in connection with the wheel motor M and a wheel W of the vehicle, and the wheel motor M drives the wheel W of the vehicle to rotate through the axle unit A1. The axle unit A1 includes a first axle All in connection with the wheel motor M, a second axle section A12 in connection with the wheel W, and a universal joint A13 provided between the first axle section and second axle section. The push rod mechanism 4 includes a joint element 41 provided on the end of the inner sleeve 34, a connecting rod 42 connected to the joint element 41, a top push rod 43 is screwed to the connecting rod 42, and a steering ball joint 44 provided on one end of the top push rod 43 and engaged with the steering ball joint 44 of the wheel W. the joint element 41 may be, for example, a universal joint A13, allowing the connecting rod 42 to be freely rotated relative to the collar element 33 through the joint element 41. One end of the connecting rod 42 is engaged with the joint element 41, and another end thereof is provided with threads screwed to the top push rod 43. The top push rod 43 can be axially moved relative to the connecting rod 42 by means of screwing to adjust the total length of the push rod mechanism 4, and the connecting rod 42 and top push rod 43 are fixed through a locking nut 45, preventing the both from relative axial movement. In the embodiment, the first transmission mechanism P1 may be a planetary gear train, bout is not limited to this.

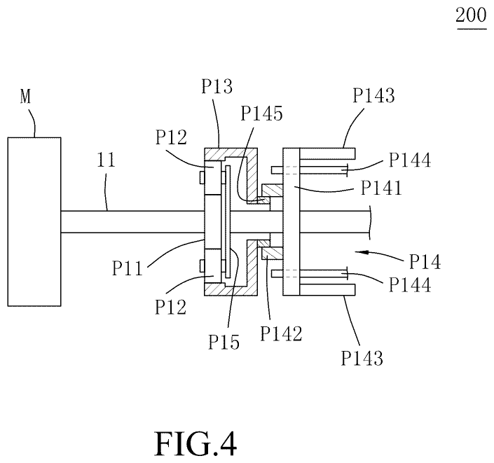

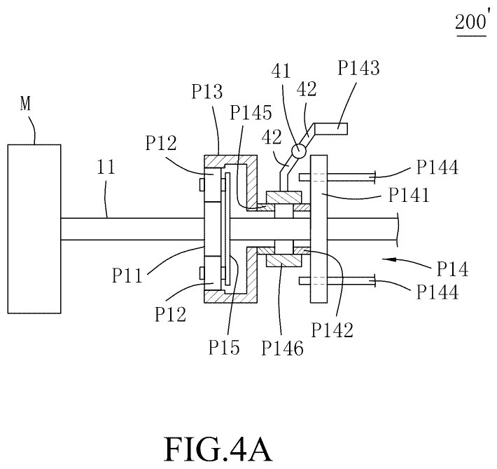

Referring to FIG. 4, the push rod device 10A of the present invention can be applied to a decelerating switching mechanism 200, and can be movably provided on the ring gear of the planetary gear train. The planetary gear train has a sun gear P11, a planet gear P12 surrounding the sun gear P11, a ring gear P13 located on the outermost ring, and a planet carrier P15 connected to the planet gear P12. A switching mechanism P14 movably holds the ring gear P13, and has a switching ring P141, an engagement gear P142 provided on the surface of the switching ring P141 facing f the ring gear P13, two positioning pins P144 fixed to the vehicle body (not shown in the figure) and passed through the switching ring P141, and two movable driving elements P143 that can drive the switching ring P141 toward or away from the ring gear 13 along the positioning pins P144. The engagement gear P142 and a connecting gear P145 engaged with the ring gear 13 are engaged with each other, thereby fixing the ring gear P13; once the ring gear P13 is fixed, the planetary gear train can then provide a large deceleration effect on the wheel 100. When the switching ring P141 drives the engagement gear P142 to be away from the ring gear and separated from it, the ring gear P12 is not fixed at this time. The switching mechanism P14 is used to control whether the ring gear P13 is fixed or not; when the ring gear P13 is not fixed, the planetary gear train can then not provide the acceleration or deceleration effect on the wheel 100. Furthermore, the push rod device 10A of the present invention can be used as a replacement component for driving element P143, capable of driving the switching ring 141 to move toward or away from the ring gear P13 along the positioning pin P144. Furthermore, the number of the positioning pins P144 is not limited to two, and can also be other number in other embodiments, only at least one is enough.

Referring to FIG. 4A, the push rod device 10A of the present invention can further be applied to a decelerating switching mechanism 200′, which is similar to the decelerating switching mechanism 200, and the difference between them is that in the decelerating switching mechanism 200, the driving element P143 is used to push the switching ring P141 to engage with the ring gear P13, but in the decelerating switching mechanism 200′, the driving element P143 pushes the switch gear P146 to move along the left and right directions in the figure through the connecting rod 42 and joint element 41. When the switch gear P146 is engaged with the connecting gear 145 of the ring gear P13 and the engagement gear P142 of the switch ring P141 at the same time, the ring gear P13 is fixed, facilitating generating the large deceleration or large acceleration function. If the switch gear P146 is moved rightward to only mesh with the engagement gear P142 of the switch ring P141, and separated from the connecting gear P145 of the ring gear P13, the ring gear P13 is not fixed, capable of direct transmission.

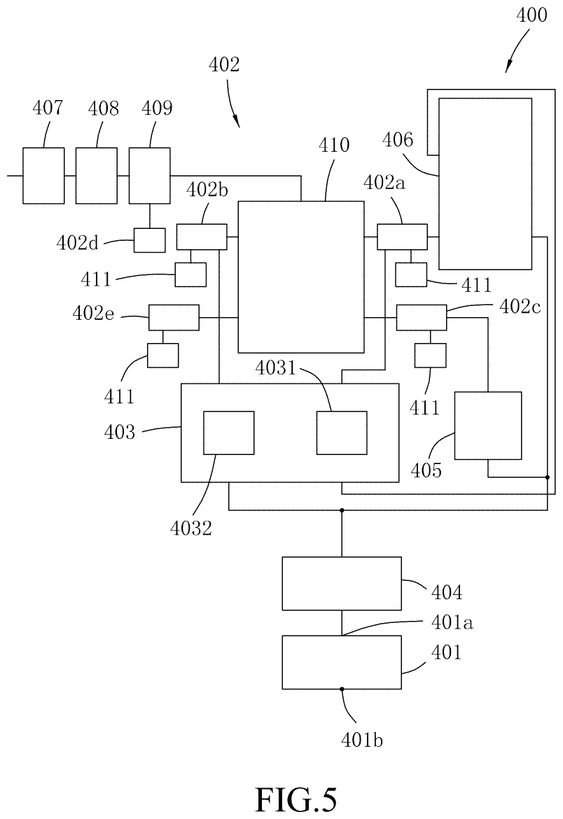

Referring to FIG. 5, the push rod device 10A of the present invention can further be applied to a range extension system 400. The range extension system 400 includes a range extension assembly 401, first fuel storage device 402, first fuel source control device 403, first humidifier 404, first fuel source auxiliary control device 405, first pressure balance valve 406, air compressor 407, pressure regulating valve 408, air dryer 409, multi-circuit protection valve 410, and discharge valve 411. The range extension assembly 401 includes a first fuel input part 401a and a second fuel input part 401b. The first fuel input part 401a is used to receive a first fuel source, and the second fuel input part 401b is used to receive a second fuel source different from the first fuel source. The first fuel source and second fuel source are mixed inside the range extension assembly 401 to generate electric power output. The range extension system 400 may be installed on a transportation vehicle such as a car, ship, or airplane that can carry the range extension assembly, and the transportation vehicle at least uses the range extension assembly 401 as a power source (for example, the transportation vehicle may be a hybrid electric car); the fuel is sent to the range extension assembly 401 to further covert into electric energy to provide the main electric source use of the transportation vehicle or to charge the main electric source to increase mileage as the use of the range extension system. The first fuel source may be, for example, oxygen or air, and second fuel source may be, for example, hydrogen, but not limited thereto.

The first fuel storage device 402 is used to store the first fuel source and to provide it to the first fuel input part 401a, and includes air tanks 402a, 402b, 402c and 402e, which are directly connected to the first fuel source control device 403. The first fuel source control device 403 is connected between each of the air tanks 402at to 402e of the first fuel storage device 402 and the first humidifier 404, and has a first actuation unit 4031 and second actuation unit 4032. The push rod device 10A of the present invention is connected to the first actuation unit 4031, and the first actuation unit 4031 links the second actuation unit 4032. When the first actuation unit 4031 is pushed by the push rod device 10A, the first fuel input part 401a is allowed to receive the first fuel source from the first fuel storage device 402. Whereby, when driving the vehicle and requiring faster acceleration, the driver can operate the push rod device 10A and continue to push the first actuation unit 4031 and link the second actuation unit 4032. The first fuel source is received form the first fuel storage device 402 and has a chemical reaction with the second fuel source in the range extension assembly 401 at the same time to increase power supplement for acceleration purpose.

The first humidifier 404 is communicated between the first fuel storage device 402 and first fuel input part 401a, allowing the fuel provided to the range extension assembly 401 to contain some water vapor to supplement the moisture contained in the polymer electrolyte membrane (such as ion exchange membrane) in the range extension assembly 401, avoiding voltage drops and reduce the chance of battery damage.

The first fuel source auxiliary control device 405 is communicated between the first fuel storage device 402 and first humidifier 404, and connected to the push rod device 10A of the present invention. When the first fuel source auxiliary control device 405 is pushed by the push rod device 10A, the first fuel input part 401a can receive the first fuel source from the first fuel storage device 402. Whereby, when the central control device of the vehicle detects insufficient power, the driver can then operate the push rod device 10A to drive the first fuel source auxiliary device 405 to quickly receive the first fuel source from the first fuel storage device 402 to have a chemical reaction with the second fuel source in the range extension assembly 401 for power supplement.

The first pressure balance valve 406 is provided below the chassis of the vehicle, actuated with the weight carried by the vehicle, and communicated between the first storage device 402 and first humidifier 404. Whereby, as the carrying weight of the vehicle increases, the first pressure balance valve 406 can be driven to open so that the first fuel of the first fuel storage device 402 is delivered to the first fuel input part 401a, thereby increasing the electrical energy output of the range extension assembly 401. The air compressor 407 is communicated with the atmosphere and used to compress air into the first fuel source. The pressure regulating valve 408 is provided between the air compressor 406 and first fuel storage device 402, adapted to regulate the pressure of the first fuel source, thereby avoiding rupture caused by excessive pressure in the pipelines connected between the components, which may cause dangerous leakage of the air source. The air dryer 409 is communicated between the air compressor 407 and first fuel source control device 403, adapted to remove the moisture in the air compressed by the air compressor 407. The discharge valve 411 is respectively communicated between the atmosphere and each air tank 402a, 402b, 402c, 402e, thereby discharging the condensate water in the air tanks 402a, 402b, 402c and 402e to the atmosphere to maintain the pressure in the air tanks 402a, 402b, 402c and 402e.

The multi-circuit protection valve 410 is communicated between the air compressor 407 and air tanks 402a, 402b, 402c and 402e, and can control whether the air tanks 402a, 402b are communicated with the first fuel source control device 403 according to a pressure threshold value. Specifically, when the actual pressure value is smaller than the pressure threshold value, the multi-circuit protection value 410 is in\a close state, and when the actual pressure value is larger than or equal to the pressure threshold value, the multi-circuit protection valve 410 is in an open state.

It should be noted that the pipeline structure shown in FIG. 5 illustrates the connection relationship between the first fuel source and other components, and the second fuel source is similar to the first fuel source and can also be matched with components such as range extension assembly 401, a second fuel storage device, a second fuel source control device, a second humidifier, a second fuel source auxiliary control device, and a second pressure balance valve, allowing the second fuel source to be sent to the range extension assembly 401 to have a chemical reaction with the first fuel source. Furthermore, the second fuel source auxiliary control device can also be connected to the push rod device 10A of the present invention, and when the second fuel source auxiliary control device is pushed by the push rod device 10A, the second fuel input part is allowed to receive the second fuel source from the second fuel storage device.

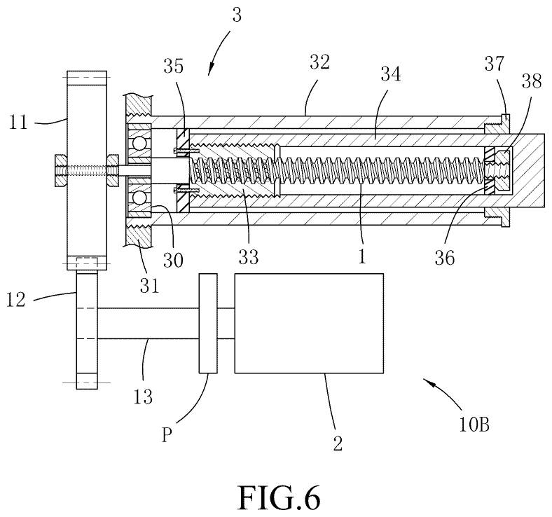

Referring to FIG. 6, in a variant embodiment of the first embodiment, the drive motor 2 of a push rod device 10B is changed to be parallel to the rotating shaft 1 and positioned on a different straight line, and the both are joined and linked by a first gear 11 fixedly sleeved on the rotating shaft 1, a second gear 12 meshed with the first gear 11 and capable of being driven by the driving motor 2, and an extension shaft 13 allowing the second gear 12 to be fixedly sleeved thereon; when the motor 2 drives the extension shaft 13 and second gear 12 to rotate, the first gear 11 and rotating shaft 1 can be driven to rotate, and the collar element 33 can also be driven to move the inner sleeve 34 to move along the rotating shaft 1.

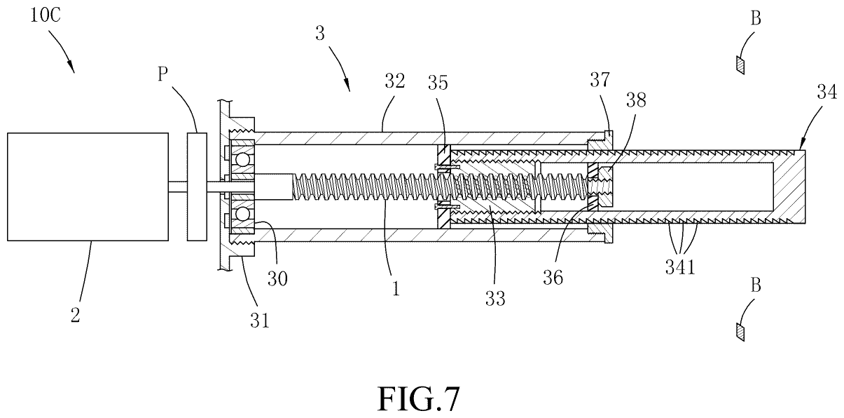

Referring to FIG. 7, in a second embodiment, a push rod device 10C of the present invention is similar to the first embodiment, the difference between them is that the inner sleeve 34 in the second embodiment is recessed to form a plurality of positioning grooves 341, which allows a plurality of corresponding positioning blocks to be engaged therewith, enabling the inner sleeve 34 to be positioned relative to the rotating shaft 1.

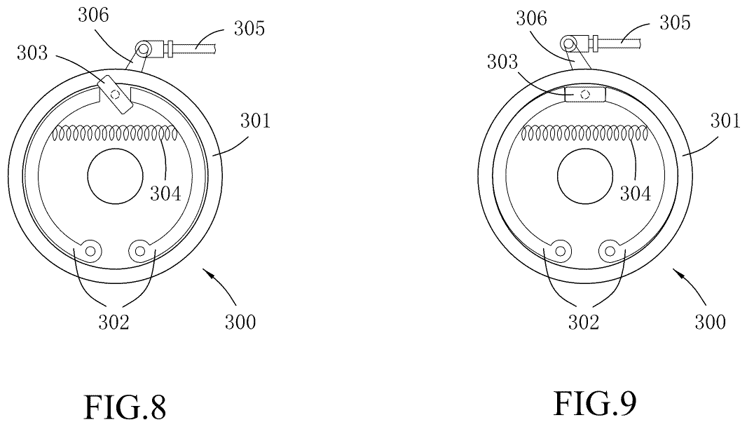

Referring to FIGS. 8 and 9, the push rod device 10C of the present invention can be applied to a vehicle brake device 300. The brake device includes a brake drum 301, two shoes 302, a rotatable cam 303, an elastic element 304 with two ends connected to the shoes 302 respectively, a push rod 305 connected to the push rod device 10C and a linkage rod 3061 inked to the cam 303. The push rod 305 is connected to the inner sleeve 34 of the push rod device 10C, allowing the inner sleeve 34 to drive the push rod 305 synchronously when the inner sleeve 34 is moved along the rotating shaft 1; the push rod 305 drives the cam 303 to rotate through the linkage rod 306, allowing the shoes 302 to touch the brake drum 301 to limit the rotation of the brake drum 301 to achieve the braking deceleration effect.

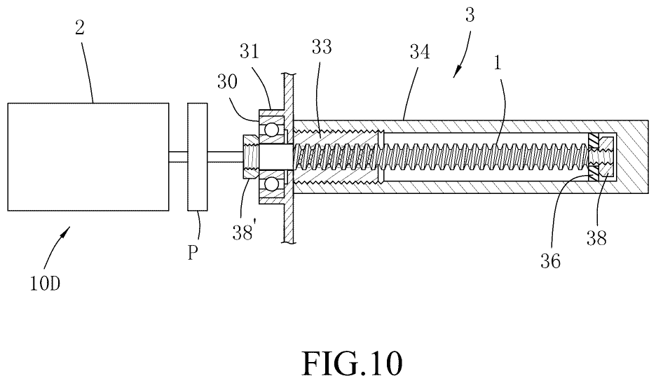

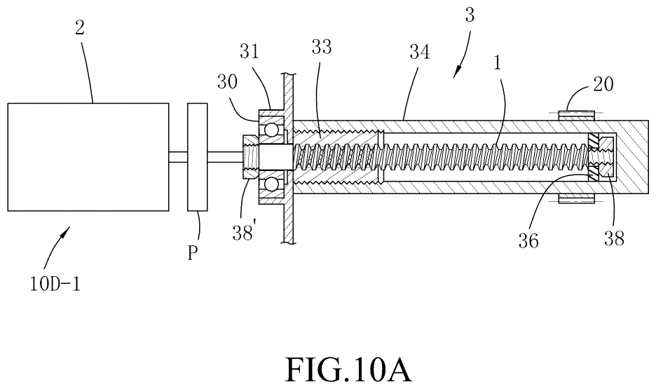

Referring to FIG. 10, in a third embodiment, a push rod device 10D of the present invention is similar to the first embodiment, the difference between them is that the outer sleeve 32 and snap ring 37 are omitted in the third embodiment, and the configuration direction of the bearing seat 31 is opposite to the configuration direction of the bearing 30, so that a nut 38 is additionally provided to fix the bearing 30. When the rotating shaft 1 is driven by the drive motor 2 to rotate, the collar element 33 is driven to move the inner sleeve 34 to move along the rotating shaft 1.

Referring to FIG. 10A, in a first variant embodiment of the third embodiment, a push rod device 10D-1 of the present invention is similar to the third embodiment, the difference between them is that the push rod device 10D-1 further includes a steering gear 20 fixedly sleeved on the inner sleeve 34.

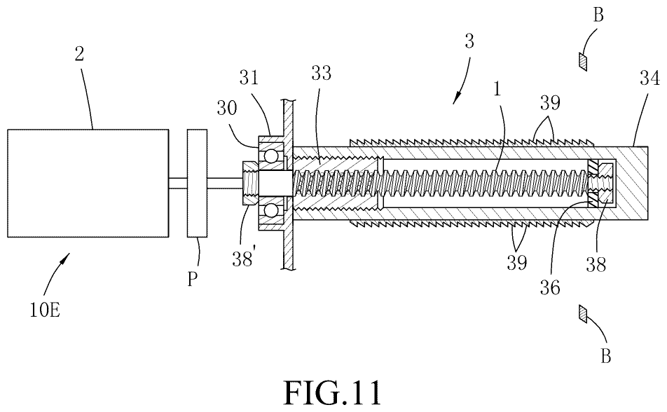

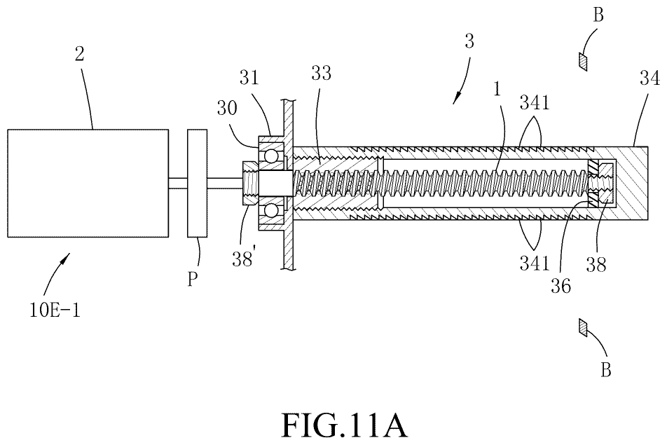

Referring to FIG. 11, in a fourth embodiment, a push rod device 10E of the present invention is similar to the third embodiment, the difference between them is that the telescopic assembly 3 further has a plurality of lock blocks 39 protruded outward from the outer wall surface of the inner sleeve 34 in the fourth embodiment, allowing the plurality of corresponding positioning blocks B to be engaged therewith, enabling the inner sleeve 34 to be positioned relative to the rotating shaft 1, where the lock blocks 39 are respectively provided on the two sides of the inner sleeve 34, and the lock blocks 39 on each side are coherently with each other.

Referring to FIG. 11A, in a first variant embodiment of the fourth embodiment, a push rod device 10E-1 is similar to the third embodiment, the difference between them is that the inner sleeve 34 of the telescopic assembly 3 is recessed to form a plurality of positioning grooves 341, which allow the plurality of corresponding positioning blocks B to be engaged therewith, enabling the inner sleeve 34 to be positioned relative to the rotating shaft 1.

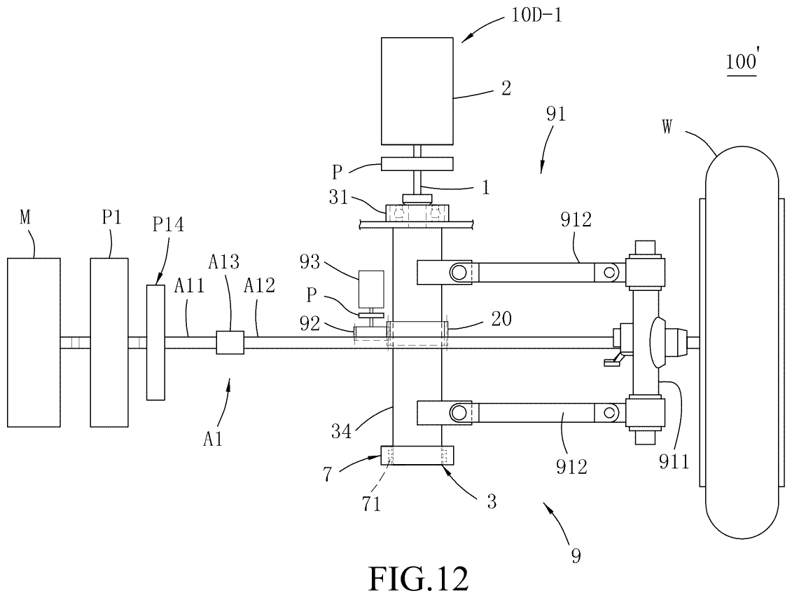

Referring to FIG. 12, the push rod device 10D-1 of the present invention can be applied to a vehicle steering system 100′, which includes a wheel motor M, first transmission mechanism P1, axle unit A1, and steering unit 9. The axle unit A1 is connected to the wheel motor M and vehicle wheel W, and the wheel motor M drives the vehicle wheel W to rotate through the axle unit A1. The axle unit A1 includes a first axle section All connected to the wheel motor M, a second axle section A12 connected to the wheel W, and a universal joint A13 provided between the first axle section and second axle section. The steering unit 9 includes a suspension assembly 91 provided on the vehicle body (not shown in the figure) and connected to the wheel W, at least one drive gear 92 connected to the suspension assembly 91, and at least one steering motor 93 provided on the vehicle body and adapted to drive the drive gear 92 to rotate. The suspension assembly 91 includes a steering knuckle 911 allowing the axle unit A1 to be passed through it and connected to the wheel, and two pairs of support arms 912 connected to the upper and lower ends of the steering knuckle 911. When the drive gear 92 is rotated, it will drive the steering gear 20 to rotate to drive the push rod device 10D-1, support arm 912, steering knuckle 911 and wheel W to rotate, achieving the purpose of the steering of the wheel w. Furthermore, when the rotating shaft 1 is rotated, the collar element 33 of the telescopic assembly 3 moves the inner sleeve 34 along the extension direction of the rotating shaft 1 back and forth with it to drive the suspension assembly 91 to move up and down relative the vehicle body. In the embodiment, the first steering mechanism P1 may be a planetary gear train, but not limit thereto.

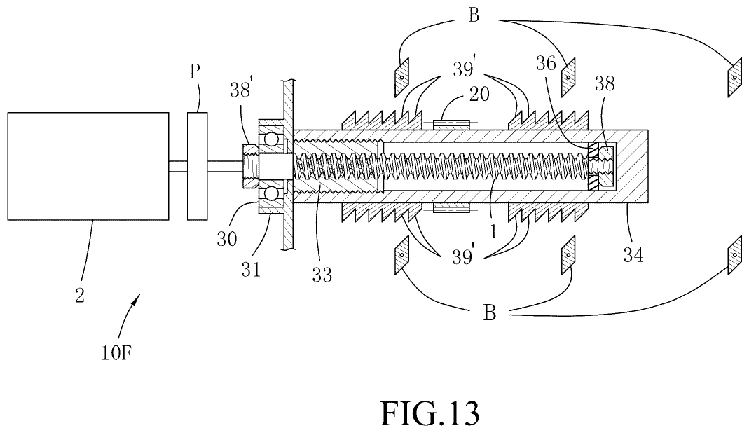

Referring to FIGS. 10 and 13, in a fifth embodiment, a push rod device 10F of the present invention is similar to the third embodiment, the difference between them is that the in the fifth embodiment, the telescopic assembly 3 further has a plurality of lock blocks 39′ protruded outward from the outer wall surface of the inner sleeve 34, the plurality of lock blocks 39′ are respectively provided on the two sides of the inner sleeve 34, and the lock blocks on each side of the inner sleeve 34 are positioned on the upper and lower sides of the steering gear 20 and can be in engagement with the plurality of corresponding positioning blocks B, allowing the inner sleeve 34 to be moved and rotated, and positioned relative to the rotating shaft 1. By engaging the positioning blocks B with the lock blocks 39′, it can assist in sharing the axial stress borne by the rotating shaft 1, lifting collar element 33, and inner sleeve 34. Furthermore, the number of the positioning blocks B is not limited to three pairs of the present embodiment, and may also be other number in another embodiment, just needing at least one pair.

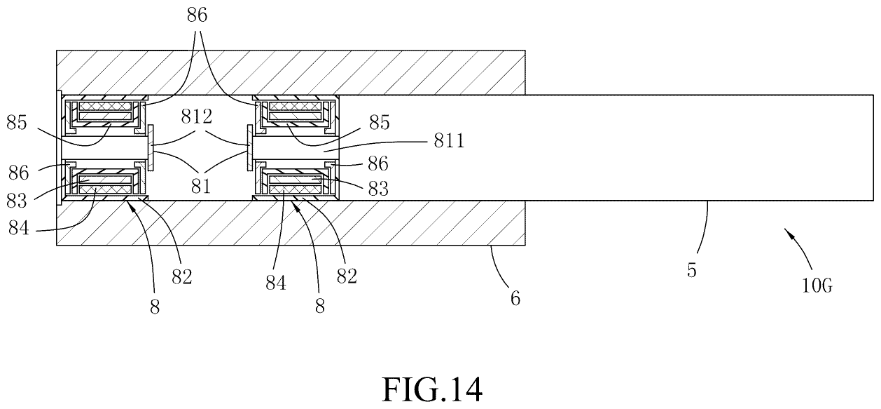

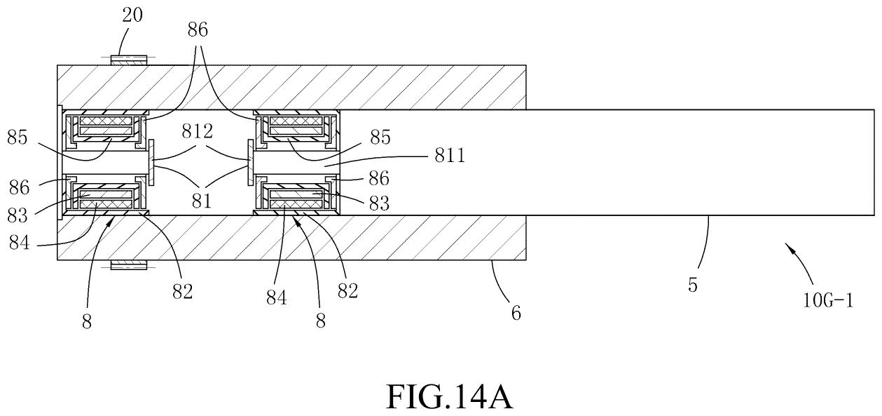

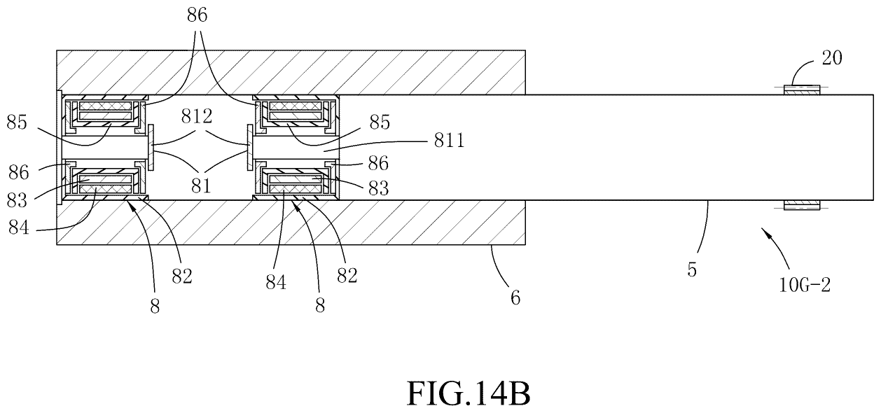

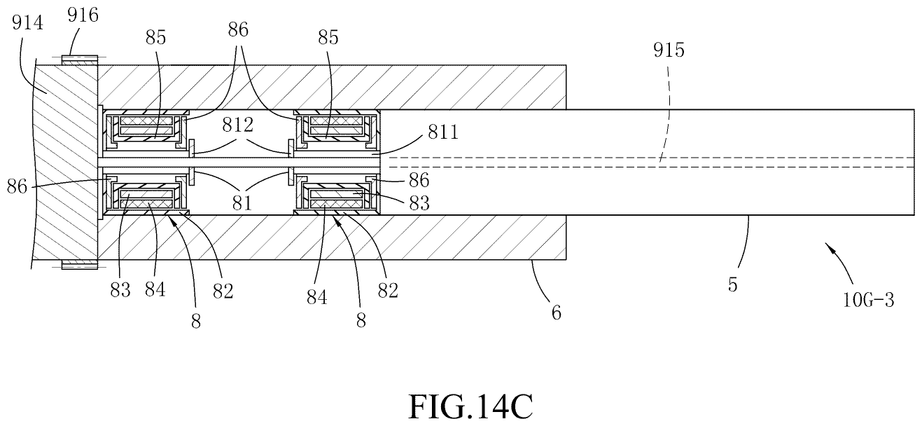

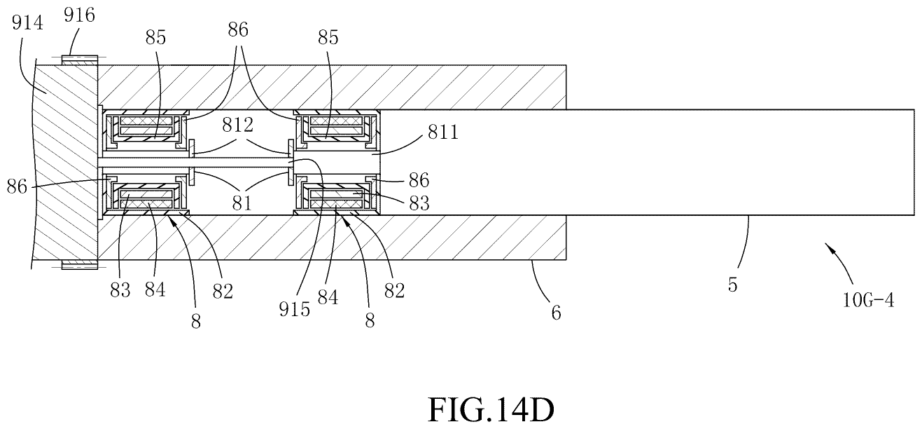

Referring to FIG. 14, in a sixth embodiment, a push rod device 10G of the present invention includes a telescopic assembly, magnetic unit and second magnetic unit. The telescopic assembly includes an inner rod 5 and outer cylinder 6.

The outer cylinder 6 may be movably sleeved on the inner rod 5. The first magnetic unit provided on the end of the inner rod 5, and the second magnetic unit is provided inside the outer cylinder 6 and corresponds to the position of the first magnetic unit. The first magnetic unit and second magnetic unit are attracted to or repelled from each other by means of magnetic force, so as to drive the outer cylinder 7 to telescopic along the inner rod 5. In the present embodiment, the first magnetic unit and second magnetic unit both are an electromagnet assembly 8. Each electromagnet assembly 8 has an extension column 81, an insulator unit sleeved on the extension column 81, a core element 83 provided inside the insulator unit, and a coil 84 provided inside the insulator unit and surrounding the cord element 83, where one of the extension columns 81 is fixed to the inner rod 5, and another one is fixed to the outer cylinder 6. Each of the extension columns 81 has a main body part 811 and a cover part 812 connected to the end of the main body part 811 and larger than the main body part 811 in diameter. In the present embodiment, the insulator part includes an insulating outer cylinder 82 sleeved on the extension column 81, a colloid 85 covered on the core element 83 and coil 84 with the insulating outer cylinder 82 together, and two lock covers 86, where one of the two lock covers 86 is provided between the colloid 85 and insulating outer cylinder 82, and another one is provided between the colloid 85 and cover part 812; the core element 83 is a soft iron core, but not limited thereto, and the core element 83 may be a nanoscale rare earth structure or silicon steel sheet laminated structure.

Referring to FIG. 14A, in a first variant embodiment of the sixth embodiment, a push rod device 10G-1 is similar to the sixth embodiment, the difference between them is that in the first variant embodiment of the sixth embodiment, the push rod device 10G-1 further includes a steering gear 20 fixedly sleeved on the outer cylinder 6, and the steering gear 20 is away from the end of the outer cylinder 6 a distance, but not limited to this form, and the steering gear 20 may be sleeved on any position of the outer surface of the outer cylinder 6 depending on requirements.

Referring to FIG. 14B, in a second variant embodiment of the sixth embodiment, a push rod device 10G-2 of the present invention is similar to the sixth embodiment, the difference between them is that the push rod device 10G-2 further includes a steering gear 20 fixedly sleeved on the inner rod 5, and the steering gear 20 is away from the end of the inner rod 5 a distance, but not limited to this form, and the steering gear 20 may be sleeved on any position of the outer surface of the outer cylinder 6 depending on requirements.

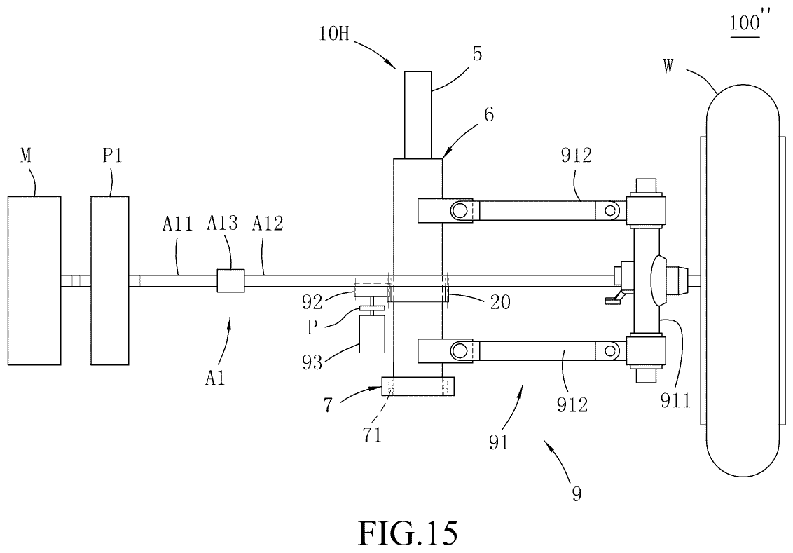

Referring to FIG. 15, in a seventh embodiment, a push rod device 10H of the present invention is similar to the sixth embodiment, the difference between them is that the push rod device 10H further includes a cylinder body seat 7 and a steering gear 20 fixedly sleeved on the outer cylinder 6 of the push rod device 10H, where the cylinder body seat 7 allows the outer cylinder 6 to be movably passed through and has two abutment rings 71 embedded in the inner wall surface of the cylinder body seat 7 and abutting the outer cylinder 6. It can be installed upright as shown in the figure, or it can be installed upside down (not shown in the figure); if it is installed upside down, the steering gear 20 is then fixedly sleeved on the inner rod 5 of the push rod device 10H, and the abutment ring of the cylinder body seat 7 then abuts the inner rod 5. Furthermore, the push rod device 10H may further applied to a vehicle steering system 100″ including a wheel motor M, first transmission mechanism P1, axle unit A1 and steering unit 9. The axle unit A1 is connected to the wheel motor M and a vehicle wheel W, where the wheel motor M drives the vehicle wheel W to rotate through the axle unit A1. The axle unit A1 includes a first axle section All connected to the wheel motor M, a second axle section A12 connected to the wheel W, and universal joint A13 provided between the first axle section and second axle section. The steering unit 9 includes a suspension assembly 91 provided on the vehicle body (not shown in the figure) and connected to the wheel W, at least one drive gear 92 connected to the suspension assembly 91, and at least one steering motor 93 provided on the vehicle body and adapted to drive the drive gear 92 to rotate. The suspension assembly 91 includes a steering knuckle 911 allowing the axle unit A1 to be passed through and connected to the wheel W, and two pairs of support arms 912 connected to the upper and lower ends of the steering knuckle 911. The drive gear 92 is meshed with the steering gear 20; when the drive gear 92 rotates, it will drive the steering gear 20 to rotate to drive the push rod device 10H, support arm 912, steering knuckle 911 and wheel W to rotate, achieving purpose of the wheel W steering. Furthermore, when the rotating shaft 1 is rotated, the outer cylinder 6 is moved back and forth along the extension direction of the rotating shaft 1 to drive the suspension assembly 91 to move up and down relative to the vehicle body. Furthermore, through the configuration of the cylinder body seat 7, the outer cylinder 6 will not shake when moved up and down. In the present invention, the first steering mechanism P1 may be a planetary gear train, but not limited thereto.

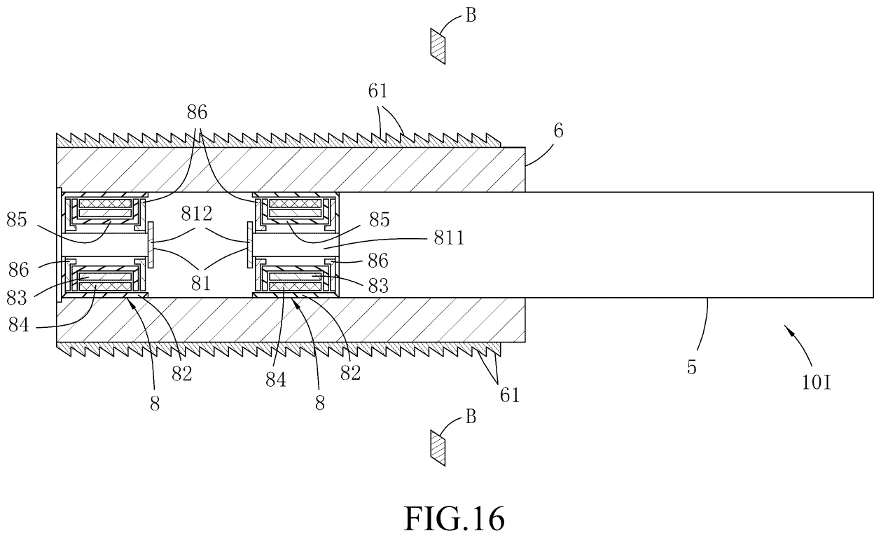

Referring to FIG. 16, in an eighth embodiment, a push rod device 101 of the present invention is similar to the sixth embodiment, the difference between them is that the push rod device 101 further has a plurality of lock blocks 61″ protruded out from the outer wall surface of the outer cylinder 6; the lock blocks 61′ allow multiple corresponding positioning blocks B to be engaged therewith, enabling the outer cylinder to be positioned relative to the inner rod 5.

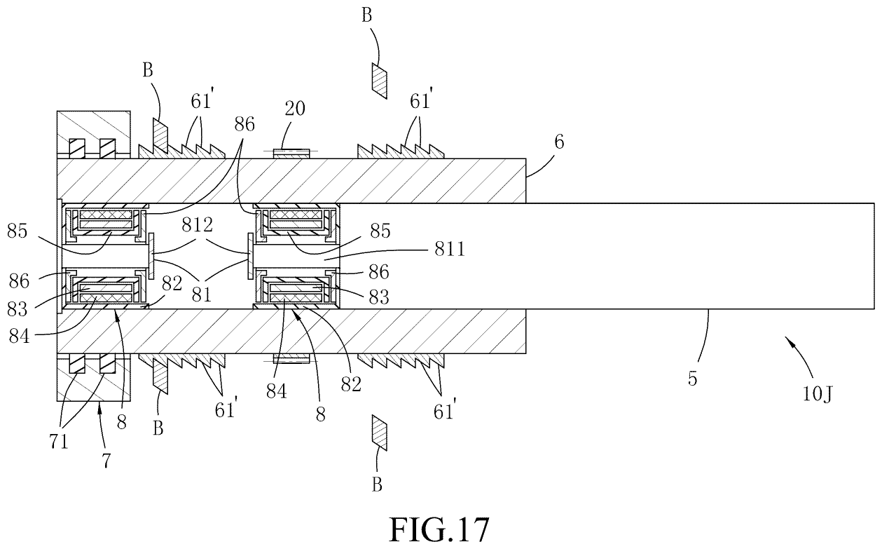

Referring to FIG. 17, in a ninth embodiment, a push rod device 10J is similar to the seventh embodiment, the difference between them is that the push rod device 10J further includes a plurality of lock blocks 61′ protruded out from the outer wall surface of the outer cylinder 6, and the lock blocks 61′ allow the multiple corresponding positioning blocks B to be engaged therewith, enabling the outer cylinder 6 to be moved, rotated and positioned relative to the inner rod 5. The lock blocks 61′ are respectively provided on the two sides of the outer cylinder 6, and the lock blocks 61′ on each side are positioned on the upper and lower sides of the steering gear 20.

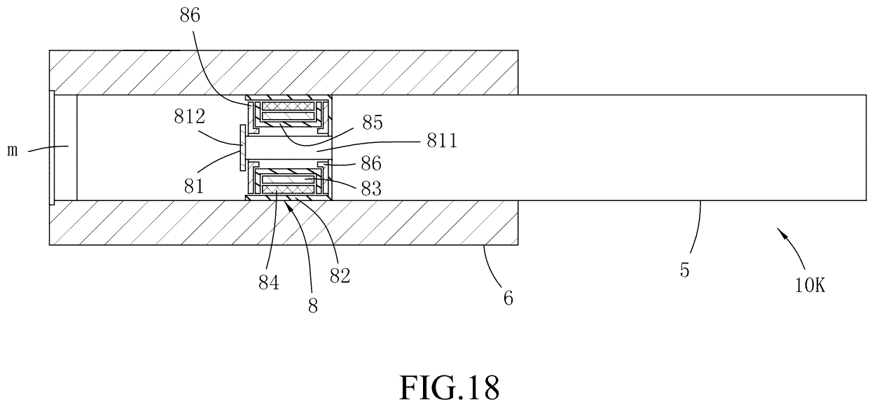

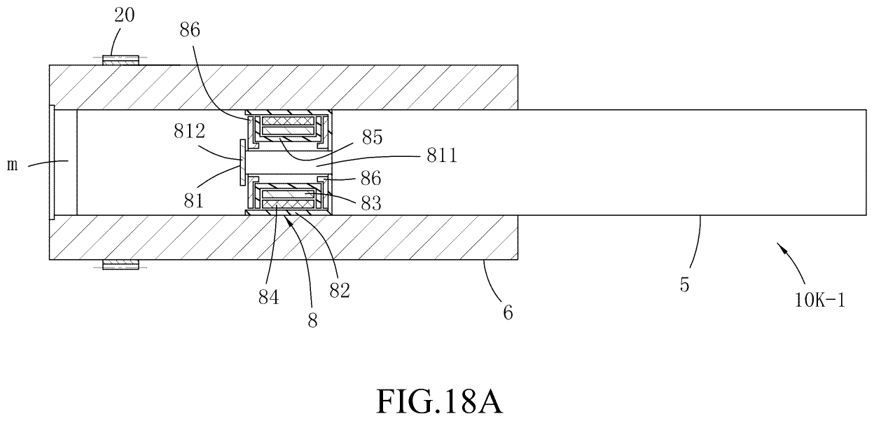

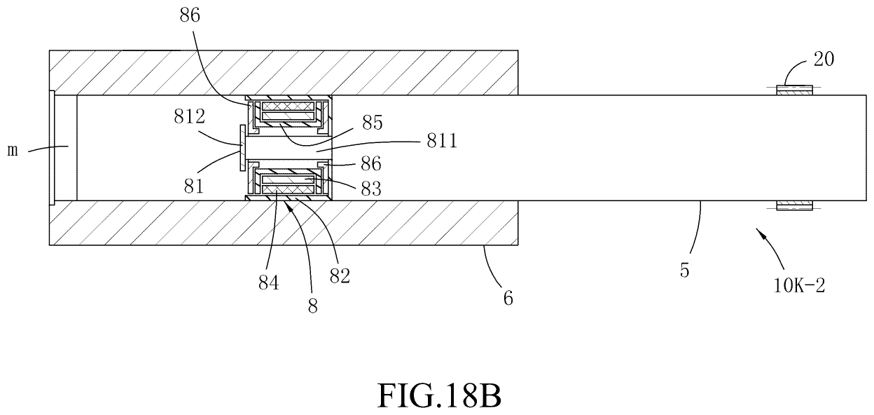

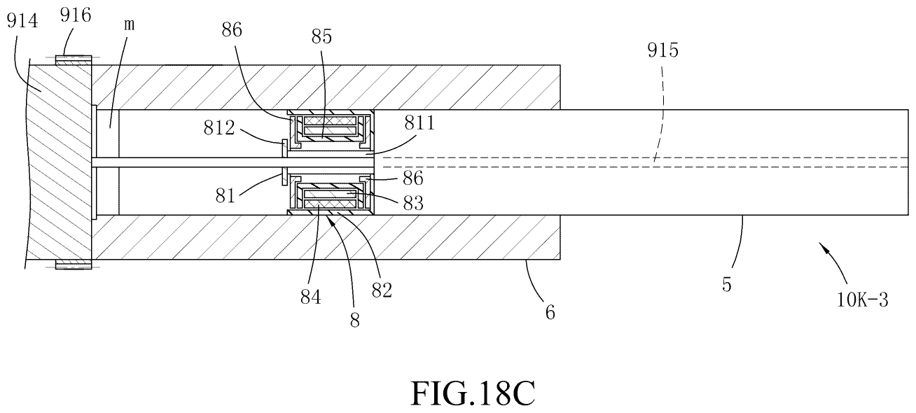

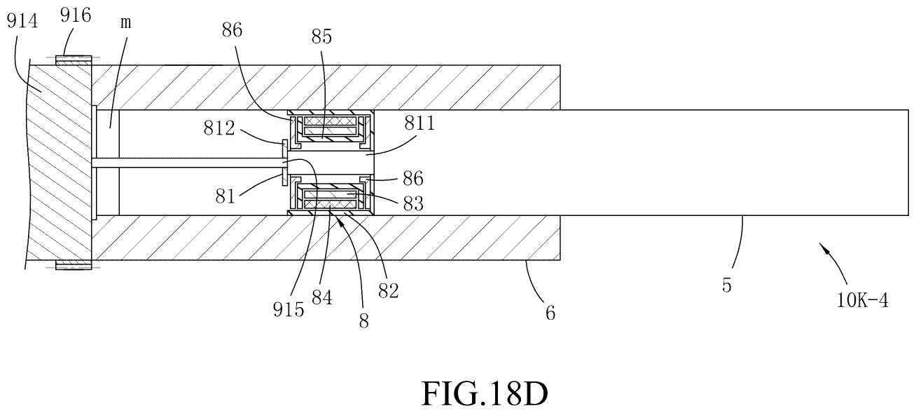

Referring to FIG. 18, in a tenth embodiment, a push rod device 10K of the present invention is similar to the sixth embodiment, the difference between them is that only the first magnetic unit is the electromagnet assembly 8, and the second magnetic unit is a permanent magnet m. By changing the magnetic polarity of the first magnetic unit, the outer cylinder 6 can also be driven to move along the inner rod 5.

Referring to FIG. 18A, in a first variant embodiment of the tenth embodiment, a push rod device 10K-1 of the present invention is similar to the tenth embodiment, the difference between them is that the push rod device 10K-1 further includes a steering gear 20 fixedly sleeved on the outer cylinder 6, and the steering gear 20 is away from the end of the outer cylinder 6 a distance, but not limited to this form, and the steering gear 20 may be sleeved on any position of the outer surface of the outer cylinder 6 depending on requirements.

Referring to FIG. 18B, in a second variant embodiment of the tenth embodiment, a push rod device 10K-2 of the present invention is similar to the tenth embodiment, the difference between them is that the push rod device 10K-2 further includes a steering gear 20 fixedly sleeved on the inner rod 5, and the steering gear 20 is away from the end of the inner rod 5 a distance, but not limited to this form, and the steering gear 20 may be sleeved on any position of the outer surface of the inner rod 5 depending on requirements.

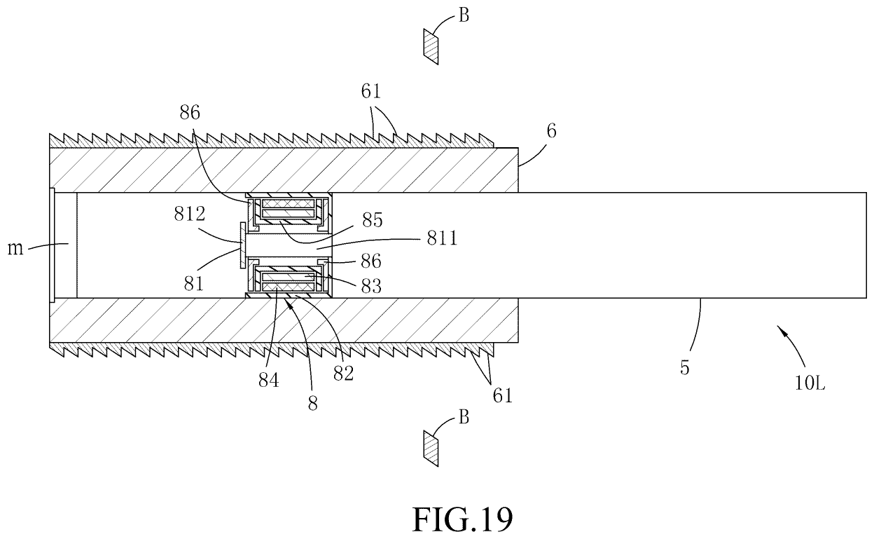

Referring to FIG. 19, in an eleventh embodiment, a push rod device 10L of the present invention is similar to the tenth embodiment, the difference between them is that the push rod device 10L further has a plurality of lock blocks protruded outward from the outer wall surface of the outer cylinder 6, and the lock blocks 61 allow multiple corresponding positioning blocks B to be engaged therewith, enabling the outer cylinder 6 to be positioned relative to the inner rod 5.

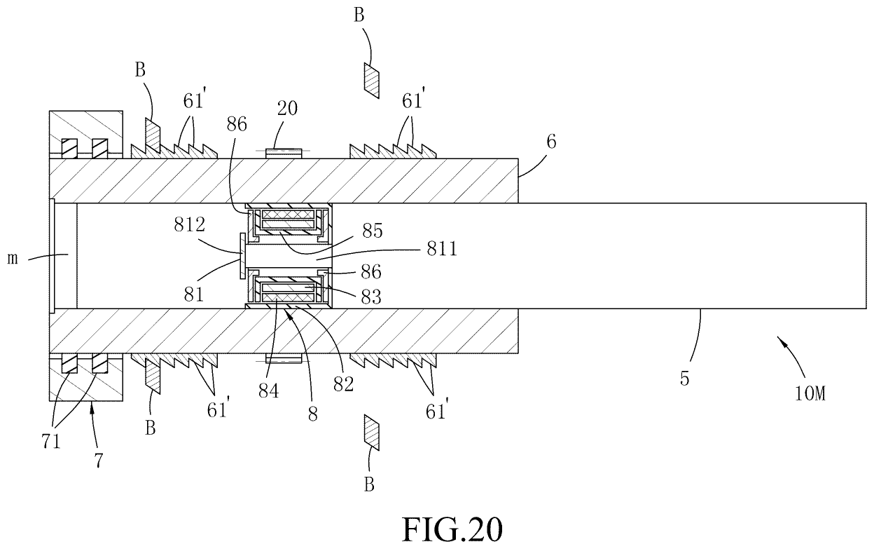

Referring to FIG. 20, in a twelfth embodiment, a push rod device 10M of the present invention is similar to the tenth embodiment, the difference between them is that the push rod device 10M further includes a plurality of lock blocks 61′ and cylinder body seats 7 protruded outward from the outer wall surface of the outer cylinder 6. The lock blocks 61′ allow multiple corresponding positioning blocks B to be engaged therewith, enabling the outer cylinder 6 to be moved, rotated and positioned relative to the inner rod 5. The lock blocks 61′ are respectively provided on the two sides of the inner sleeve 34, and the lock blocks 61′ on each side are positioned on the upper and lower sides of the steering gear 20.

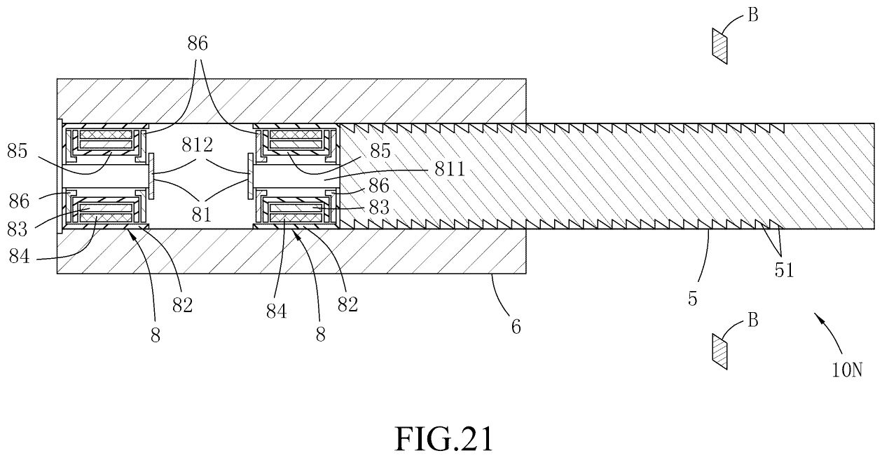

Referring to FIG. 21, in a thirteenth embodiment, a push rod device 10N of the present invention is similar to the sixth embodiment, the difference between them is that the outer cylinder 6 is fixed, and the inner rod 5 can be moved relative to the outer cylinder 6. Furthermore, the inner rod 5 is recessed to form a plurality of positioning grooves 51. The positioning grooves 51 allow multiple corresponding positioning blocks B to be engaged therewith, enabling the inner rod 5 to be positioned relative to the outer cylinder 6.

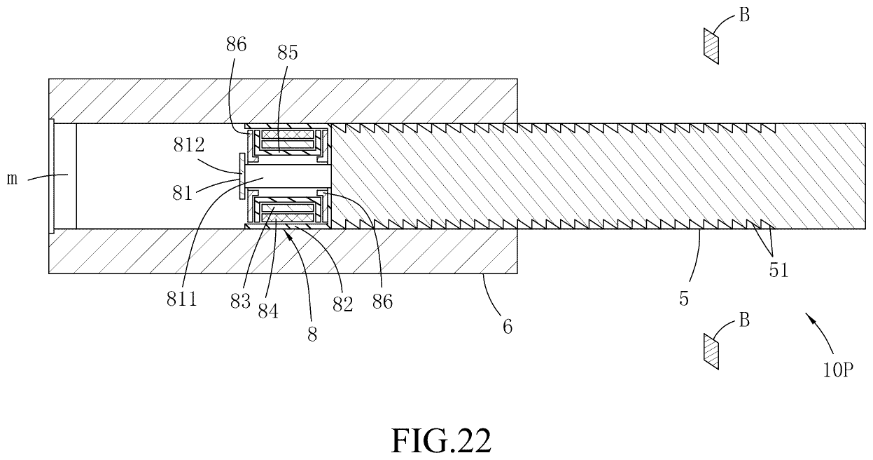

Referring to FIG. 22, in a fourteenth embodiment, a push rod device 10P is similar to the eleventh embodiment, the difference between them is that only the first magnetic unit is a permanent magnet m, and the second magnetic unit is an electromagnet assembly 8. By changing the magnetic polarity of the second magnetic unit, the inner rod 5 can also be driven to move relative to the outer cylinder 6.

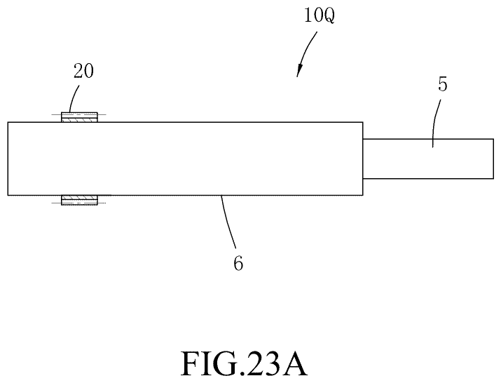

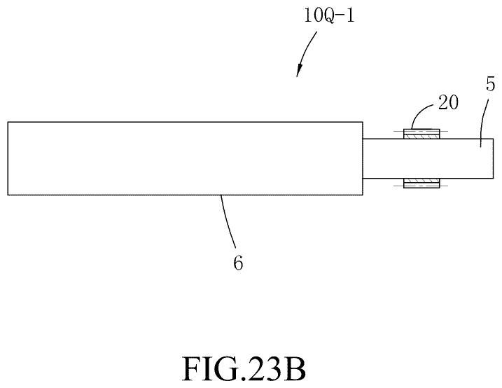

Referring to FIG. 23A, in a fifteenth embodiment, a push rod device 10Q of the present invention is similar to the sixth embodiment, the difference between is that the outer cylinder 6 is driven by means of air pressure or oil pressure to move along the inner rod 5, and the push rod device 10Q further includes a steering gear 20 fixedly sleeved on the outer cylinder 6.

Referring to FIG. 23B, in a first variant embodiment of the fifteenth embodiment, a push rod device 10Q-1 of the present invention is similar to the fifteenth embodiment, the difference between them is that the steering gear 20 of the push rod device 10Q-1 is fixedly sleeved on the inner rod 5.

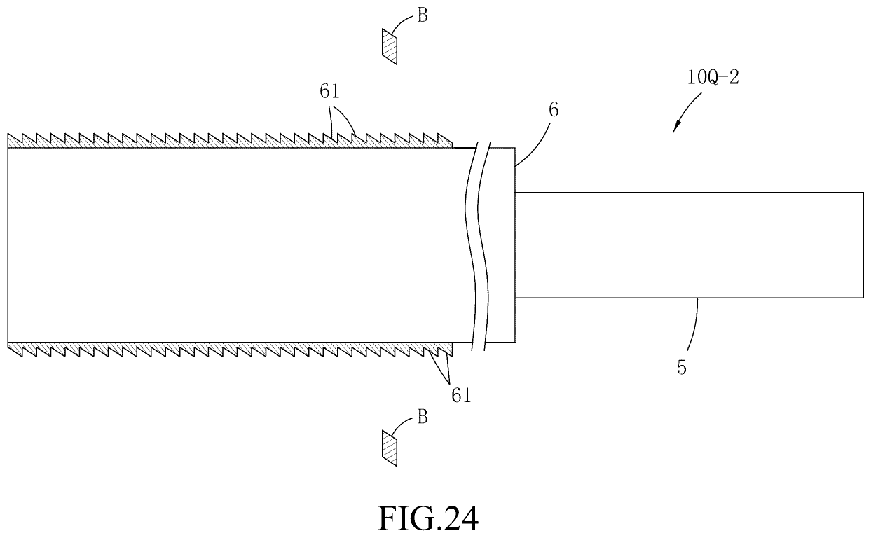

Referring to FIG. 24, in a second variant embodiment of the fifteenth embodiment, a push rod device 10Q-2 of the present invention is similar to the fifteenth embodiment, the difference between them is that the push rod device 10Q-2 does not have the steering gear 20, but further has a plurality of lock blocks 61 protruded outward from the outer wall surface of the outer cylinder 6, and the lock blocks 61 allow multiple corresponding positioning blocks B to be engaged therewith, enabling the outer cylinder 6 to be moved, rotated and positioned relative to the inner rod 5.

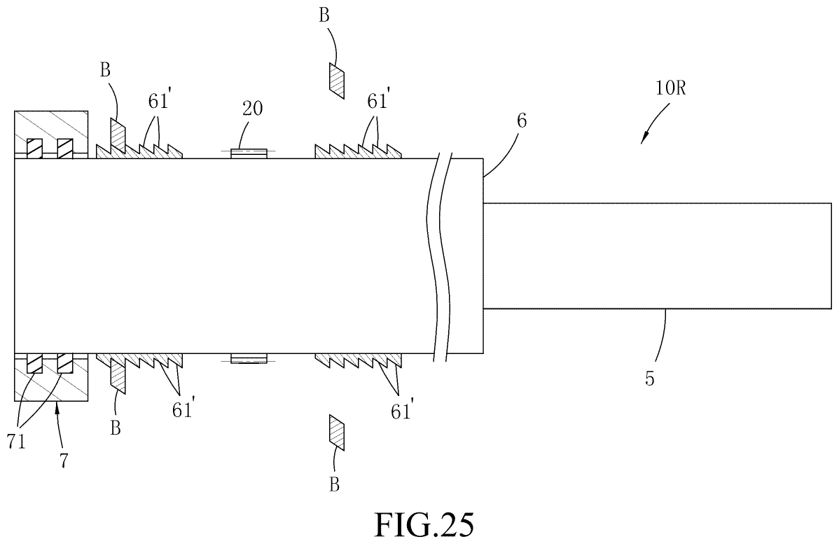

Referring to FIG. 25, in a sixteenth embodiment, a push rod device 10R of the present invention is similar to the sixth embodiment, the different between them is that the outer cylinder 6 is driven by means of air pressure or oil pressure to move along the inner rod. Furthermore, the push rod device 10R further includes a plurality of lock blocks 61′ and cylinder body seats 7 protruded outward from the outer cylinder 6. The lock blocks 61′ allow multiple corresponding positioning blocks B to be engaged therewith, enabling the outer cylinder 6 to be positioned relative to the inner rod 5. The lock blocks 61′ are respectively provided on the two sides of the inner sleeve 34, and the lock blocks 61′ on each side are positioned on the upper and lower sides of the steering gear 20.

It should be noted that the above first to sixteenth embodiments can all be applied to the steering system 100 as shown in FIG. 3, the steering system 100′ as shown in FIG. 12, the steering system 100″ as shown in FIG. 15, the deceleration switching mechanism 200 as shown in FIG. 4, the range extension system 400 as shown in FIG. 5, and the brake device 300 as shown in FIGS. 8 and 9. What needs to be supplemented is that the component connection relationships in the sixth to fourteenth embodiments are slightly different when applied. In the sixth to twelfth embodiments, the inner rods 5 are all fixed, and the outer cylinder 6 is connected to the push rod mechanism 4 of the steering system 100 and the push rod 305 of the brake device 300. However, in the thirteenth and fourteenth embodiments, the outer cylinders 6 are all fixed, but the inner rod 5 is connected to the push rod mechanism 44 of the steering system 100, the push rod 305 of the brake device 300. The above two connection manners all can achieve the same effects. Furthermore, in the push rod devices of FIGS. 11,16, 19 and 24, the lock blocks 39 and 61 can be changed to the forms of the positioning groove 341 and 51, which can also have the positioning function. Supplementary instructions are as follows, the push rod devices 10A, 10B, 10D, 10G, 10H, and 10K of the present invention can be applied to the deceleration switching mechanism 200, the push rod device 10A, 10B, 10D, 10G, 10H and 10K of the present invention can be applied to the range extension system 400, the push rod devices 10C, 10E, 10E-1, 10I, 10L, 10N, 10P, 10Q-2 of the present invention can be applied to the vehicle brake device 300, the push rod device 10A, 10B, 10D, 10G, 10K, 10C, 10E, 10E-1, 10I, 10L, 10N, 10P, 10Q-2 of the present invention can be applied to the steering system 100, the push rod devices 10A-1, 10D-1, 10F of the present invention can be applied to the steering system 100′, the push rod devices 10G-1, 10G-2, 10H, 10J, 10K-1, 10K-2, 10M, 10Q, 10Q-1, 10R of the present invention can be applied to the steering system 100″.

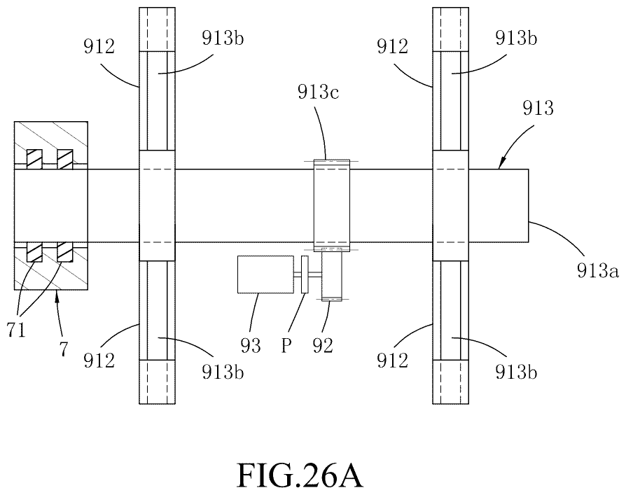

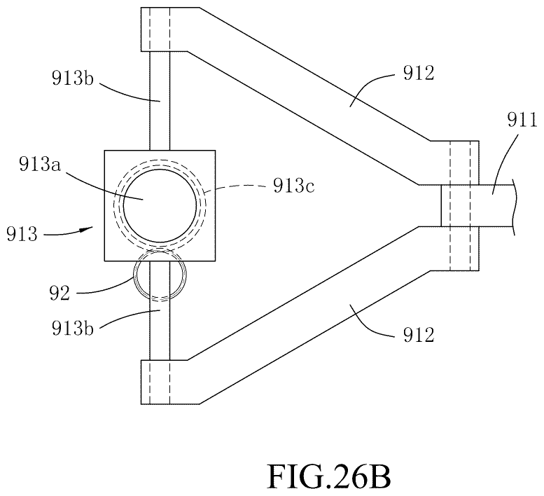

Referring to FIGS. 15, 26A and 26B, it is not limited to this example. The push rod device of the present invention can further be applied to a vehicle steering system. The present steering system is similar to the steering system 100″, the difference between them is that the suspension assembly 91 of the steering unit 9 of the present vehicle steering system further has extension frame 913, and the support arms number two pairs. Each pair of support arms is roughly Y-shaped, and the extension frame 913 includes a spindle 913a extended up and down, two pairs of pivot shafts 913b respectively extended toward the support arm, and an extension steering gear 913c fixedly sleeved on the spindle 913a and meshed with the drive gear 92. The spindle 913a can be connected to the inner sleeves 34 of the push rod devices 10A, 10B and 10D, the outer cylinder 6 or inner rod 5 of the push rod device 10G, the outer cylinder 6 or inner rod 5 of the push rod device 10K by means of welding, riveting, bolt connection, internal and external thread joint or integrated formation, and not limited thereto. When the drive gear 92 is rotated, it will drive the extension steering gear 913c to rotate to drive the push rod device, support arm 912, steering knuckle 911 and wheel W to rotate, achieving the purpose of wheel W steering.

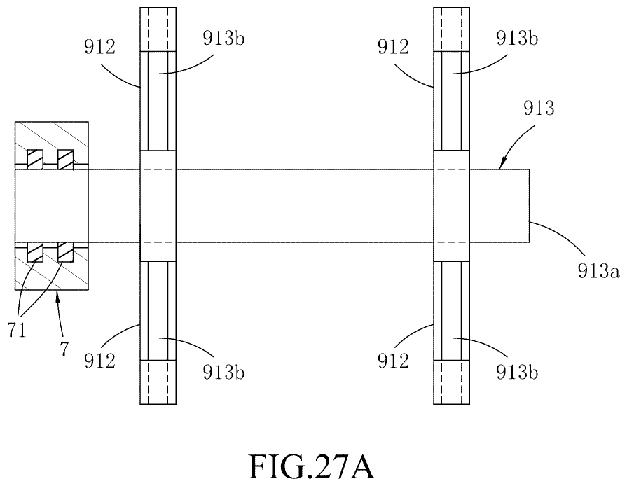

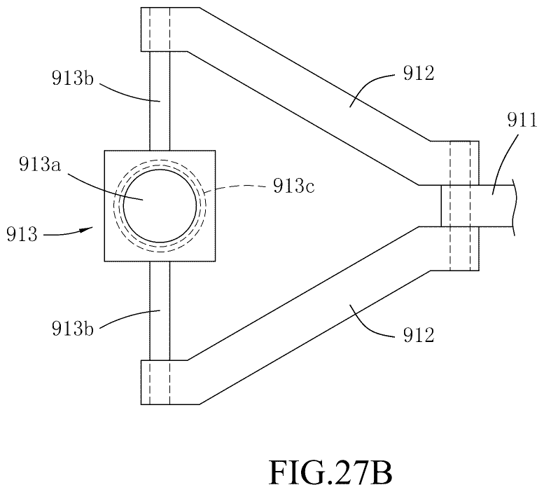

Further referring to FIGS. 15, 27A and 27B, it is not limited to this example. The push rod device of the present invention can further be applied to a vehicle steering system. The present steering system is similar to the steering system 100″, the difference between them is that the suspension assembly 91 of the steering unit 9 of the present steering system further has an extension frame 913, and the support arms 912 number two pairs. Each pair of support arm is Y-shaped, and the extension frame 913 includes a spindle 913a extended up and down and two pairs of pivot shafts 913b respectively extended toward the support arm from the spindle. The spindle 913a can be connected to the inner sleeves 34 of the push rod device of FIGS. 2A and 10A, the outer cylinder 6 of the push rod device of FIG. 14A, FIG. 18A, FIG. 23, the inner rod 5 of the push rod device of FIG. 14B, FIG. 18B by means of welding, riveting, bolt connection, internal and external thread joint or integrated formation, and not limited thereto. When the drive gear 92 is rotated, it will drive the steering gear 20 to rotate to drive the push rod device, support arm 912, steering knuckle 911 and wheel W to rotate, achieving the purpose of wheel W steering.

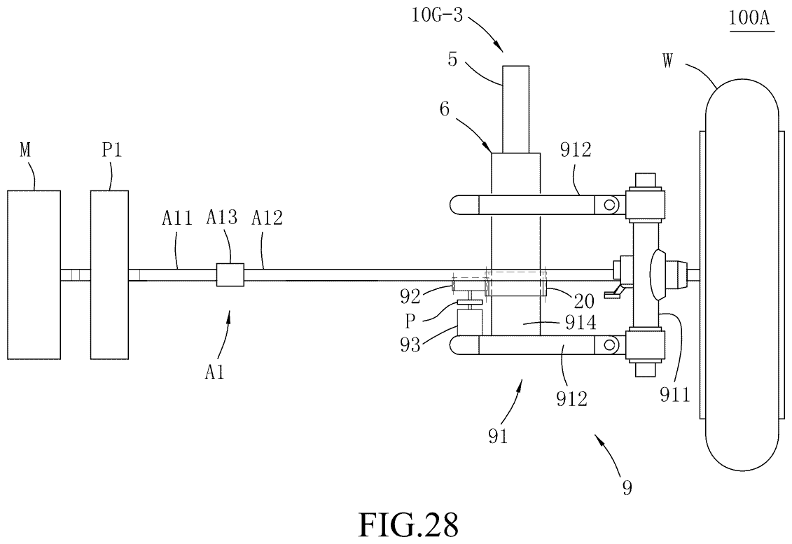

Referring to FIGS. 14C, 18C and 28, it is not limited to this example. In a third variant embodiment 10G-3 of the sixth embodiment, and in a third variant embodiment 10K-3 of the tenth embodiment, a push rod device 10G-3 and push rod device 10K-3 of the present invention can further respectively be applied to a vehicle steering system 100A. The steering system 100A includes a wheel motor M, first transmission mechanism P1, axle unit A1 and steering unit 9. The axle unit A1 is connected to the wheel motor M and a vehicle wheel W, and the wheel motor M drives the vehicle wheel W to rotate through the axle unit A1. The axle unit A1 includes a first axle section A11 connected to the wheel motor M, a second axle section A12 connected to the wheel W, and a universal joint A13 provided between the first axle section and second axle section. The steering unit 9 includes a suspension assembly 91 provided on the vehicle body (not shown in the figures) and connected to the wheel W, at least one drive gear 92 connected to the suspension assembly 91, and at least one steering motor 93 provided on the vehicle body and used to drive the drive gear 92 to rotate. The suspension assembly 91 includes a steering knuckle 911 allowing the axle unit A1 to be passed through it and connected to the wheel W, two pairs of support arms 912 connected to the vehicle body and the upper and lower ends of the steering knuckle 911, a shock absorber 914 connected to the support arm 912 located below and the outer cylinder 6 of the push rod device, a connecting column 915 connected to the shock absorber 914, passed through and penetrated in the inner rod 5 and connected to the vehicle body (not shown in the figures), and a shock absorber steering gear 916 fixedly sleeved on the shock absorber and meshed with the drive gear. When the drive gear 92 is rotated, it will drive the shock absorber steering gear 916 to rotate to drive the push rod device support arm 912, steering knuckle 911 and wheel W to rotate, achieving the purpose of wheel W steering. Furthermore, the shock absorber 914 may also be connected to the support arm 912 located above, not limited by these embodiments.

Referring to FIGS. 14D, 18D and 28, it is not limited to this example. In a fourth variant embodiment 10G-4 of the sixth embodiment, and a fourth variant embodiment 10K-4 of the tenth embodiment, a push rod device 10G-4 and push rod device 10K-4 can also respectively be applied to a vehicle steering system 100A. The difference thereof is that the connecting column 915 of the fourth variant embodiment 10G-4 of the sixth embodiment, the fourth variant embodiment 10K-4 of the tenth embodiment is connected to the main body part 811 of the extension column 81 is connected to the inner rod 5 by means of welding, riveting, bolt connection, internal and external thread joint or integrated formation.

To sum up, the push rod device of the present invention drives the rotating shaft 1 to rotate through the drive motor 2, so that the telescopic assembly 3 can be moved along the extension direction of the rotating shaft 1, achieving the effect of pushing objects. It is very convenient to use, and its simple structure can effectively save the space required for installation and the difficulty of installation, so it can indeed achieve the purpose of the present invention.

The above mentioned are only embodiments of the present invention. When the scope of the present invention cannot be limited by this, any simple equivalent changes and modifications made according to the claims and patent specifications of the present invention still fall within the scope of the present invention patent.

1. A push rod device, characterized in that said push rod device comprises:
a rotating shaft;
a drive motor, connected to said rotating shaft, and adapted to drive said rotating shaft to rotate; and
a telescopic assembly, capable of movably provided on said rotating shaft, and said telescopic assembly being telescoped along an extension direction of said rotating shaft when said rotating shat is rotated.

2. The push rod device according to claim 1, characterized in that said telescopic assembly comprises a bearing seat allowing said rotating shaft to be rotatably passed therethrough, an outer sleeve fixed to said bearing seat, a collar element movably sleeved on said rotating shaft, and an inner sleeve positioned inside said outer sleeve and fixed to said collar element.

3. The push rod device according to claim 2, characterized in that said telescopic assembly further has a first sealing element fixed to said collar element and sleeved between said rotating shaft and outer sleeve, and a second sealing element sleeved between one end of said rotating shaft away from said bearing seat and said inner sleeve.

4. The push rod device according to claim 2, characterized in that an outer wall surface of said inner sleeve is recessed to form a plurality of positioning grooves allowing a plurality of corresponding positioning blocks to be engaged therewith, enabling said inner sleeve to be positioned relate to said rotating shaft.

5. The push rod device according to claim 1, characterized in that said telescopic assembly comprises a bearing seat allowing said rotating shaft to be rotatably passed therethrough, a collar element movably engaged with said rotating shaft, and an inner sleeve fixed to said collar element.

6. The push rod device according to claim 5, characterized in that said telescopic assembly further has a second sealing element sleeved between one end of said rotating shaft away from said bearing seat and said inner sleeve.

7. The push rod device according to claim 5, characterized in that said telescopic assembly further has a plurality of lock blocks protruded outward from an outer wall surface of said inner sleeve, and said lock blocks allow a plurality of corresponding positioning blocks to be engaged therewith, enabling said inner sleeve to be positioned relative to said rotating shaft.

8. The push rod device according to claim 5, characterized in that an outer wall surface of said inner sleeve is recessed to form a plurality of positioning grooves allowing a plurality of corresponding positioning blocks to be engaged therewith, enabling said inner sleeve to be positioned relative to said rotating shaft.

9. The push rod device according to claim 7, characterized in that said lock blocks are respectively provided on two sides of said inner sleeve, and said lock blocks on each side are arranged coherently with each other.

10. The push rod device according to claim 7, further comprising a steering gear fixedly sleeved on said inner sleeve, and said lock blocks are respectively provided on two sides of said inner sleeve, and said lock blocks on each side are positioned on upper and lower sides of said steering gear.

11. The push rod device according to claim 2, further comprising a steering gear fixedly sleeved on said inner sleeve.

12. The push rod device according to claim 5, further comprising a cylinder body seat allowing said inner sleeve to be movably passed therethrough.

13. The push rod device according to claim 2, further comprising a deceleration mechanism connected to said drive motor and rotating shaft.

14. The push rod device according to claim 13, characterized in that said deceleration mechanism is a planetary gear train.

15. A push rod device, characterized in that said push rod device comprises:
a telescopic assembly, comprising an inner rod, and an outer cylinder movably sleeved on said inner rod;
a first magnetic unit, provided on an end of said inner rod; and
a second magnetic unit, provided inside said outer cylinder and corresponding to a position of said first magnetic unit,
wherein, said first magnetic unit and second magnetic unit are attracted to or repelled from each other through magnetic force, thereby driving said outer cylinder to telescope along said inner rod.

16. The push rod device according to claim 15, characterized in that said first magnetic unit and second magnetic unit respectively are an electromagnet assembly.

17. The push rod device according to claim 16, characterized in that each of said electromagnet assemblies has an extension column, an insulator unit provided on said extension column, a core element provided inside said insulator unit, and a coil provided inside said insulator unit and surrounding said core element, characterized in that one of said extension columns is fixed to said inner rod, and another extension column is fixed to said outer cylinder.

18. The push rod device according to claim 17, characterized in that each of said extension columns has a main body part, and a cover part connected to an end of said main body part and having a diameter larger than said main body part, said insulator unit comprises an insulating outer cylinder sleeved on said extension column, a colloid covered on said core element and coil together with said insulating outer cylinder, and two lock covers, wherein one of said lock covers is provided between said colloid and insulating outer cylinder, and another lock cover is provided between said colloid and cover part.

19. The push rod device according to claim 15, wherein said first magnetic unit is an electromagnet assembly, and said second magnetic unit is a permanent magnet.

20. The push rod device according to claim 19, characterized in that each of said electromagnet assemblies has an extension column fixed to said inner rod, an insulator unit provided on said extension column, a core element provided inside said insulator unit, and a coil provided inside said insulator unit and surrounding said core element.

21. The push rod device according to claim 20, characterized in that said extension column has a main body part, and a cover part connected to an end of said main body part and having a diameter larger than said main body part, said insulator unit comprises an insulating outer cylinder sleeved on said extension column, a colloid covered on said core element and coil together with said insulating outer cylinder, and two lock covers, wherein one of said lock covers is provided between said colloid and insulating outer cylinder, and another lock cover is provided between said colloid and cover part.

22. The push rod device according to claim 16, further comprising a steering gear fixedly sleeved on said outer cylinder.

23. The push rod device according to claim 16, further comprising a steering gear fixedly sleeved on said inner rod.

24. The push rod device according to claim 15, further comprising a cylinder body seat allowing said outer cylinder to be movably passed therethrough.

25. The push rod device according to claim 16, characterized in that said outer cylinder is recessed to form a plurality of positioning grooves allowing a plurality of corresponding positioning blocks to be engaged therewith, enabling said outer cylinder to be positioned relative to said inner rod.

26. The push rod device according to claim 16, further comprising a plurality of lock blocks protruded outward from an outer wall surface of said outer cylinder, and said lock blocks allow a plurality of corresponding positioning blocks to be engaged therewith, enabling said outer cylinder to be positioned relative to said inner rod.

27. The push rod device according to claim 26, characterized in that said lock blocks are respectively provided on two sides of said outer cylinder, and said lock blocks on each side are arranged coherently with each other.

28. The push rod device according to claim 26, further comprising a steering gear fixedly sleeved on said outer cylinder, and said lock blocks are respectively provided inside said outer cylinder, and said lock blocks on each side are positioned on upper and lower sides of said steering gear.

29. The push rod device according to claim 16, characterized in that said inner rod is recessed to form a plurality of positioning grooves allowing a plurality of corresponding positioning blocks to be engaged therewith, enabling said inner rod to be positioned relative to said outer cylinder.

30. The push rod device according to claim 17, characterized in that said core element is a soft iron core, nanoscale rare earth structure or silicon steel sheet laminated structure.

31. The push rod device according to claim 5, further comprising a steering gear fixedly sleeved on said inner sleeve.

32. The push rod device according to claim 5, further comprising a deceleration mechanism connected to said drive motor and rotating shaft.

33. The push rod device according to claim 32, characterized in that said deceleration mechanism is a planetary gear train.

34. The push rod device according to claim 19, further comprising a steering gear fixedly sleeved on said outer cylinder.

35. The push rod device according to claim 19, further comprising a steering gear fixedly sleeved on said inner rod.

36. The push rod device according to claim 19, characterized in that said outer cylinder is recessed to form a plurality of positioning grooves allowing a plurality of corresponding positioning blocks to be engaged therewith, enabling said outer cylinder to be positioned relative to said inner rod.

37. The push rod device according to claim 19, characterized in that said outer cylinder is recessed to form a plurality of positioning grooves allowing a plurality of corresponding positioning blocks to be engaged therewith, enabling said outer cylinder to be positioned relative to said inner rod.

38. The push rod device according to claim 37, characterized in that said lock blocks are respectively provided on two sides of said outer cylinder, and said lock blocks on each side are arranged coherently with each other.

39. The push rod device according to claim 37, further comprising a steering gear fixedly sleeved on said outer cylinder, and said lock blocks are respectively provided inside said outer cylinder, and said lock blocks on each side are positioned on upper and lower sides of said steering gear.

40. The push rod device according to claim 19, characterized in that said inner rod is recessed to form a plurality of positioning grooves allowing a plurality of corresponding positioning blocks to be engaged therewith, enabling said inner rod to be positioned relative to said outer cylinder.

41. The push rod device according to claim 20, characterized in that said core element is a soft iron core, nanoscale rare earth structure or silicon steel sheet laminated structure.
